(19) United States
(12) Patent Application Publication
(10) Pub. No.: US 2010/0162258 A1
(43) Pub. Date: Jun. 24, 2010

(54) ELECTRONIC SYSTEM WITH CORE COMPENSATION AND METHOD OF OPERATION THEREOF

(75) Inventor: Yosuke Muraki, Tokyo (JP)

Correspondence Address: LAW OFFICES OF MIKIO ISHIMARU, 333 W. EL CAMINO REAL, SUITE 330, SUNNYVALE, CA, 94087, US

(73) Assignees: SONY CORPORATION, Tokyo (JP); SONY ELECTRONICS INC., Park Ridge, NJ (US)

(21) Appl. No.: 12/343,473

(22) Filed: Dec. 23, 2008

(51) Int. Cl. G06F 9/46

(52) U.S. Cl. 718/104

(57) ABSTRACT

A method of operation of an electronic system is provided including operating an integrated circuit device having a first core and a second core; detecting a first latency value between the first core and the second core; storing the first latency value in the first core; and compensating for the first latency value in the first core for a first transfer between the first core and the second core.

### TECHNICAL FIELD

The present invention relates generally to electronic systems and more particularly to electronic systems having multiple computing devices.

### BACKGROUND ART

Modem consumer electronics, such as game consoles, notebook computers, smart phones, personal digital assistants, and location based services devices, as well as enterprise class electronics, such as servers, storage arrays, and routers, are packing more integrated circuits into an ever-shrinking physical space with expectations for decreasing cost and increasing performance. Contemporary electronics expose integrated circuits to more demanding and sometimes new environmental conditions, such as cold, heat, and humidity. Higher performance, more functions, lower power usage, and longer usage off battery power are yet other expectations upon contemporary electronics.

As more functions are packed into integrated circuits and more integrated circuits into a package, more heat is generated degrading the performance, the reliability, and the lifetime of the integrated circuits as well as the overall system. Numerous technologies have been developed to meet these new requirements. Some of the research and development strategies focus on the integrated circuit technologies and associated integrated circuit packaging. Other focus on other forms of thermal management solutions, such as heat sinks/slug, heat spreaders, or localized fans directly over the integrated circuit. Yet other solutions may use a combination of solutions.

As a more specific example, recent industrial nanoscale research and development has shown promise for reducing the size of memory and logic circuits in information technology applications. In particular, the multi-core CPU era has arrived. As transistor density increases, the number of transistors making up a single computer core will not change significantly, but the number of cores packaged on the die may grow exponentially.

As different cores in a multi-core electronic system may be utilized differently, the overall performance or reliability of the entire electronic system can depend on the performance and reliability not only of each core but also the performance between the cores. Performance can vary between cores interacting with each other are directly neighboring each other or separated across a large die.

Thus, a need still remains for an electronic system with dynamically improving the performance, lowering manufacturing cost, improving yield, and improving reliability for the electronic systems. In view of the ever-increasing need to save costs and improve efficiencies, it is more and more critical that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of an electronic system including operating an integrated circuit device having a first core and a second core; detecting a first latency value between the first core and the second core; storing the first latency value in the first core; and compensating for the first latency value in the first core for a first transfer between the first core and the second core.

The present invention provides an electronic system including an integrated circuit device having a first core and a second core; a first latency detect circuit for detecting a first latency value between the first core and the second core; a first latency storage for storing the first latency value in the first core; and a first latency compensator circuit in the first core for compensating the first latency value for a first transfer between the first core and the second core.

Certain embodiments of the invention have other aspects in addition to or in place of those mentioned or obvious from the above. The aspects will become apparent to those skilled in the art from a reading of the following detailed description when taken with reference to the accompanying drawings.

### BRIEF DESCRIPTION OF THE DRAWINGS

FIGS. 1A, 1B, and 1C are schematic views of electronics systems as application examples with embodiments of the present invention.

FIG. 2 is an isometric view of an electronic assembly system in an embodiment of the present invention.

FIG. 3 is a block diagram view of a portion of the integrated circuit device.

FIG. 4 is a block diagram view of a portion of the first core.

FIG. 5 is a block diagram view of a portion of the second core.

FIG. 6 is a flow chart of an electronic system for operation of the electronic system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

Likewise, the drawings showing embodiments of the system are semi-diagrammatic and not to scale and, particularly, some of the dimensions are for the clarity of presentation and are shown greatly exaggerated in the drawing FIGs. Generally, the invention can be operated in any orientation. In addition, where multiple embodiments are disclosed and described having some features in common, for clarity and ease of illustration, description, and comprehension thereof, similar and like features one to another will ordinarily be described with like reference numerals.

For expository purposes, the term “horizontal” as used herein is defined as a plane parallel to the plane or surface of the integrated circuit, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements.

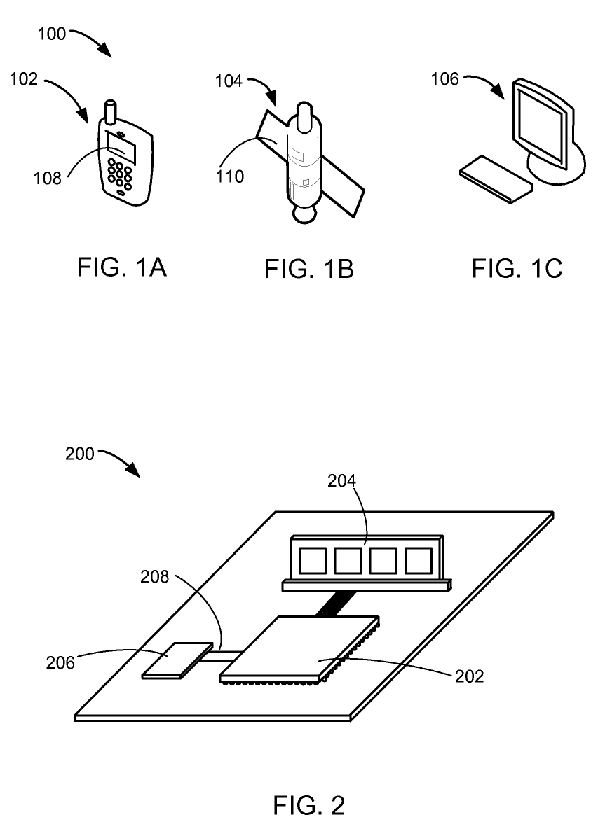

Referring now to FIG. 1A, 1B, and 1C, therein are shown schematic views of electronics systems 100 as application examples with embodiments of the present invention. A smart phone 102, a satellite 104, and a computing system 106 are examples of the electronic systems 100 using the present invention.

The electronic systems 100 may be any system that performs any function for the creation, transportation, storage, and consumption of information. For example, the smart phone 102 may create information by transmitting voice to the satellite 104. The satellite 104 is used to transport the information to the computing system 106. The computing system 106 may be used to store the information. The smart phone 102 may also consume information sent from the satellite 104. The smart phone 102 provides a display 108 as part of the interface. The satellite 104 has mechanical devices 110, such as the solar panels.

The electronic systems 100, such as the smart phone 102, the satellite 104, and the computing system 106, include a one or more of the electronic subsystem (not shown), such as a printed circuit board having the present invention or an electronic assembly having the present invention. The electronic systems 100 may also be implemented as an adapter card.

Referring now to FIG. 2, therein is shown an isometric view of an electronic assembly system 200 in an embodiment of the present invention. The electronic assembly system 200 may be included in the electronic systems 100 as exemplified by the smart phone 102 of FIG. 1A, the satellite 104 of FIG. 1B, and the computing system 106 of FIG. 1C.

The electronic assembly system 200 includes an integrated circuit device 202, such as a packaged integrated circuit or a flip chip, connected to a memory device 204, such as a dual in-line memory module, and a support device 206. The integrated circuit device 202 may operate on the data and software code from the memory device 204.

Operation of the electronic assembly system 200 may provide image to the display 108 of FIG. 1A or move the mechanical devices 110 of FIG. 1B. Results from the operation of the integrated circuit device 202 may be stored back to the memory device 204 for future use or for data retention purposes. Mapping outputs 208 from the support device 206 may interact with the data and the software code within the integrated circuit device 202.

For illustrative purposes, the electronic assembly system 200 shows the integrated circuit device 202, the memory device 204, and the support device 206 as discrete devices, although it is understood that the device partition in the electronic assembly system 200 may be different. For example, the support device 206 in part or as a whole may be included in the integrated circuit device 202.

Also as an example, the memory device 204 may include volatile memory, non-volatile memory, or a combination thereof. Specific examples of volatile memory include static random memory access (SRAM) devices or dynamic random memory access (DRAM) devices. Specific examples of the non-volatile memory include read only memory (ROM), electrical programmable read only memory (EPROM), Flash memory, and rotating memory, such as hard disk drives. For illustrative purposes, the memory device 204 is shown with a memory hierarchy having a single level, although it is understood that the memory device 204 may represent a system memory hierarchy having multiple levels.

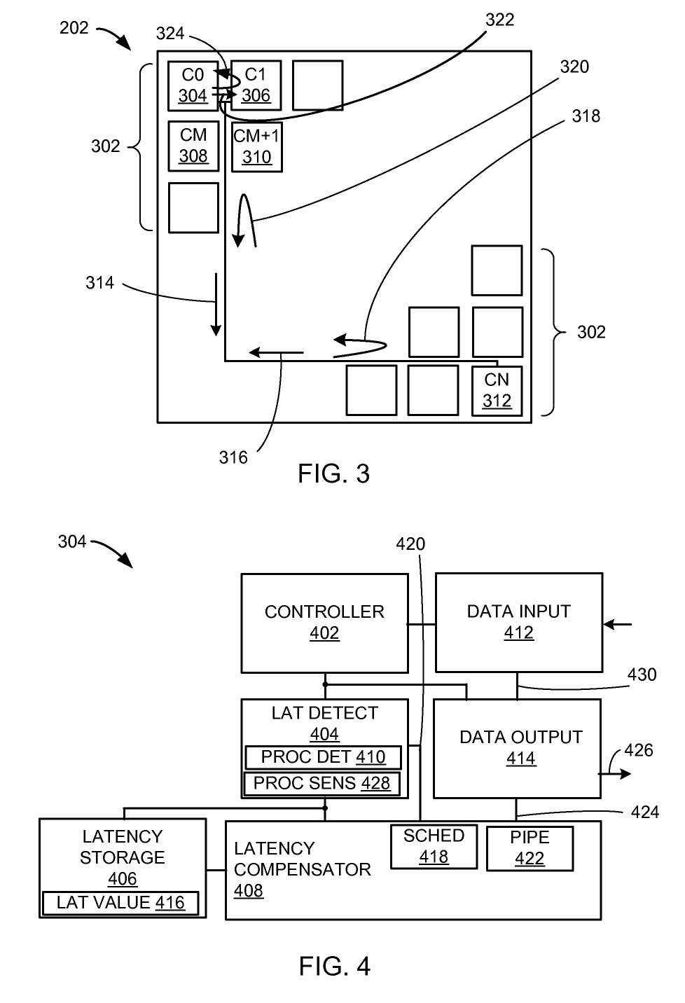

Referring now to FIG. 3, therein is a block diagram view of a portion of the integrated circuit device 202. The block diagram does not depict functional blocks that may be found in the integrated circuit device 202. For example, a clock generator (not shown), a power on reset circuit (not shown), input/output ring (not shown), and an interface block (not shown), for clarity. The block diagram depicts a portion of cores 302, such as processor cores or bit slice cores, in the integrated circuit device 202. Not all the cores 302 are shown for clarity.

A first core 304 is one of the cores 302 and is shown located at the upper left corner of the array of the cores 302. For illustrative purposes, the integrated circuit device 202 is shown with the cores 302 in an array configuration, although it is understood that the integrated circuit device 202 can have the cores 302 in a different configuration. For example, the cores 302 may not populate the integrated circuit device 202 in an array configuration or may be non-uniformly distributed across the integrated circuit device 202.

A first adjacent core 306 and a second adjacent core 308 are shown next to the first core 304. A third adjacent core 310 is shown next to the first adjacent core 306 and the second adjacent core 308 as well as to the first core 304.

A second core 312 is one of the cores 302 and is shown located at the opposite corner of the array of the cores 302. The distance between the first core 304 and the second core 312 is greater than the distance between the first core 304 and the first adjacent core 306, the second adjacent core 308, or the third adjacent core 310. The greater the distance between the cores 302 can result in increased latency of transfer or signal transmission between the cores 302.

For example, a transfer between the first core 304 and the first adjacent core 306 can occur within one system clock (not shown). A first transfer 314 from the first core 304 to the second core 312 can require more than one cycle or multiple cycles of the system clock to complete. A second transfer 316 from the second core 312 to the first core 304 can also require more than one cycle or multiple cycles of the system clock to complete.

A first round trip transfer 318 between the first core 304 and the second core 312 that starts from the first core 304 can take more cycles of the system clock than a round trip transfer between the first core 304 and an adjacent core, such as the first adjacent core 306. A second round trip transfer 320 between the second core 312 and the first core 304 that starts from the second core 312 can take more cycles of the system clock than a round trip transfer between the second core 312 and a core immediately adjacent to the second core 312.

A third transfer 322 from the first core 304 to the first adjacent core 306 can require the least amount of time for the third transfer 322, compared to the time required for the first transfer 314. A third round trip transfer 324 from the first core 304 to the first adjacent core 306 and returning to the first core 304 can take more time than the first round trip transfer 318.

Referring now to FIG. 4, therein is shown a block diagram view of a portion of the first core 304. The first core 304 can have a number of functional blocks. For example, the first core 304 can include a first controller 402, a first latency detect circuit 404, a first latency storage 406, a first latency compensator circuit 408, a first data input 412, and a first data output 414.

The first controller 402 can provide the intelligence for operating the first core 304 and for controlling the interaction of the first core 304 with the other of the cores 302 of FIG. 3 as well as the rest of the electronic assembly system 200 of FIG. 2. The first controller 402 can receive data, control signals, or status from the first data input 412. The first controller 402 can operate or start the first latency detect circuit 404. The first controller 402 can also control the operation of the first data output 414.

For illustrative purposes, the integrated circuit device 202 of FIG. 3 is shown with the first core 304 having the first controller 402, although it is understood that the integrated circuit 202 can have a different configuration. For example, the integrated circuit device 202 can have the first controller 402 external to the first core 304. Also as an example, the integrated circuit device 202 can have the first controller 402 shared among multiple cores in the array of the cores 302 of FIG. 3.

The first latency detect circuit 404 can operate or cooperate with the first latency storage 406. The first latency detect circuit 404 can be used to detect the measure the latency. For example, the first latency detect circuit 404 can include a first process detection circuit 410, such as a performance sort ring oscillator, a bank of performance sort ring oscillator, or a programmable tap performance sort ring oscillator. The first process detection circuit 410 can provide a frequency to a first process sense circuit 428.

The first process sense circuit 428 can measure the frequency from the first process detection circuit 410 for mapping the characteristic of the integrated circuit device 202. An example of the characteristic of the integrated circuit device 202 is where the integrated circuit device 202 falls in a process distribution. From this characteristic information, the first detect circuit 404 can store a first latency value 416 for the first transfer 314 of FIG. 3 or the first round trip transfer 318 of FIG. 3 into the first latency storage 406.

The first latency value 416 can represent the latency, such as a variation of system clock cycles, between the first core 304 and a destination core, such as the first adjacent core 306 of FIG. 3, the second adjacent core 308 of FIG. 3, or the second core 312 of FIG. 3. The system clock can be a common clock for the cores 302. Skew and timing of the system clock between the cores 302 can be controlled to a predetermined tolerance such that the cores 302 can function synchronously between the cores 302 relative to the system clock.

For simplifying the description of the present invention, the destination core will be the second core 312 without limitation such that the present invention can have a latency value between the first core 304 and each of the cores 302 of FIG. 3. These latency values can be detected by the first latency detect circuit 404 and stored in the first latency storage 406.

The first latency compensator circuit 408 can extract the first latency value 416 from the first latency storage 406 to compensate for the latency between the cores 302. A first schedule circuit 418 of the first latency compensator circuit 408 can use the first latency value 416 to schedule the first data output 414 for transfer to the second core 312.

The first schedule circuit 418 can order the data for the first transfer 314 into a first data pipe 422 of the first latency compensator circuit 408. The first data pipe 422 can generate a first compensated data 424 by compensating the data for the first transfer 314 to shift timing of the data output earlier or later relative to the system clock. The first data pipe 422 can be bypassed or function as a block-to-block buffer to the first data output 414 resulting in an uncompensated data for the first compensated data 424.

As a different example, the first schedule circuit 418 can schedule the first round trip transfer 318 from the first core 304 to the second core 312 and returning back to the first core 304 for compensating the first latency value 416. The first schedule circuit 418 can compensate for the first round trip transfer 318 for the first latency value 416 from the first core 304 to the second core 312 and for another latency of the first latency value 416 back from the second core 312 to the first core 304.

For illustrative purposes, the first round trip transfer 318 is described with the latency from the first core 304 to the second core 312 is the same as the latency from the second core 312 to the first core 304, although it is understood that the first round trip transfer 318 may have different latency values based on direction. For example, first round trip transfer 318 is a combination of the first transfer 314 and the second transfer 316. The first transfer 314 can traverse different metal lines (not shown), vias (not shown), and distance (not shown) than the second transfer 316.

The first data input 412 can be connected to the first data output 414. This allows a first loopback transfer 430 of the data into the first core 304 to be transferred back out. An example of the first loopback transfer 430 can be back to the second core 312 as the core originating the incoming data.

The latency can be compensated as needed. For example, the first latency 416 can be updated based on changes environmental conditions to the integrated circuit device 202. Examples of the environmental changes include temperature and voltage.

The first controller 402 can be implemented with different structures. For example, the first controller 402 can be implemented as a processor core, a bit sliced core, or a finite state machine. The first test pattern generator 410 can be implemented with different structures. For example, the first test pattern generator 410 can be implemented with a finite state machine for generating a training pattern, such as a synchronization pattern, a walking ones pattern, a walking zeroes pattern, or a reserved pattern, for the first test pattern 420.

The first latency storage 406 can be implemented with different structures. For example, the first latency storage 406 can be implemented with a static random access memory (SRAM), a non-volatile random access memory (NVRAM), a dynamic random access memory (DRAM), a register file, or a combination thereof.

The first latency compensator circuit 408 can be implemented with different structures. For example, the first latency compensator circuit 408 can be implemented with analog circuitry, a single finite state machine, a number of finite state machines cooperating with each other, or a programmable finite state machine. The first schedule circuit 418 and the first data pipe 422 can also be implemented with various finite state machines. The first data pipe 422 can also be implemented with buffer structures, such as a first-in first-out (FIFO), a ring FIFO, a queue implemented with a FIFO, or a list implemented with a FIFO.

It has been discovered that the present invention provided an integrated circuit device having multiple cores with improved testability, reliability, and yield by identifying the latencies between the cores, storing these latencies between the cores, and compensating transfers between the cores using the latency values. The known latency values allow predictable testing and use of lower cost testers by not having complex test programs with large number of masking and timing functions to strobe test results. The known latency values allows for robust pass or fail test criteria as opposed to failing part that may have marginal timing between certain cores thereby improving yield and lowering cost. The known latency values or the ability to update latency values improves reliable performance of the integrated circuit device and subsequently the electronic subassembly and the electronic system.

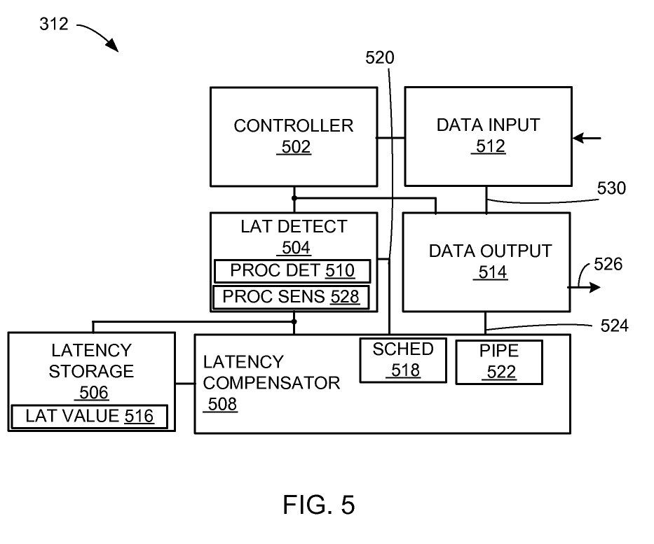

Referring now to FIG. 5, therein is shown a block diagram view of a portion of the second core 312. The second core 312 can have a number of functional blocks and be similar or the same structure as the first core 304 of FIG. 4. For example, the second core 312 can include a second controller 502, a second latency detect circuit 504, a second latency storage 506, a second latency compensator circuit 508, a second data input 512, and a second data output 514.

The second controller 502 can provide the intelligence for operating the second core 312 and for controlling the interaction of the second core 312 with the other of the cores 302 of FIG. 3 as well as the rest of the electronic assembly system 200 of FIG. 2. The second controller 502 can receive data, control signals, or status with the second data input 512. The second controller 502 can operate or start the second latency detect circuit 504. The second controller 502 can also control the operation of the second data output 514.

For illustrative purposes, the integrated circuit device 202 of FIG. 3 is shown with the second core 312 having the second controller 502, although it is understood that the integrated circuit 202 can have a different configuration. For example, the integrated circuit device 202 can have the second controller 502 external to the second core 312. Also as an example, the integrated circuit device 202 can have the second controller 502 shared among multiple cores in the array of the cores 302 of FIG. 3.

The second latency detect circuit 504 can operate or cooperate with the second latency storage 506. The second latency detect circuit 504 can be used to detect the measure the latency. For example, the second latency detect circuit 504 can include a second process detection circuit 510, such as a performance sort ring oscillator, a bank of performance sort ring oscillator, or a programmable tap performance sort ring oscillator. The second process detection circuit 510 can provide a frequency to a second process sense circuit 528.

The second process sense circuit 528 can measure the frequency from the second process detection circuit 510 for mapping the characteristic of the integrated circuit device 202. An example of the characteristic of the integrated circuit device 202 is where the integrated circuit device 202 falls in a process distribution. From this characteristic information, the second detect circuit 504 can store a second latency value 516 for the second transfer 314 of FIG. 3 or the second round trip transfer 318 of FIG. 3 into the second latency storage 506.

The second latency value 516 can represent the latency, such as a variation of system clock cycles, between the second core 312 and a destination core, such as the second adjacent core 308 of FIG. 3, the second adjacent core 308 of FIG. 3, or the second core 312 of FIG. 3. The system clock can be a common clock for the cores 302. Skew and timing of the system clock between the cores 302 can be controlled to a predetermined tolerance such that the cores 302 can function synchronously between the cores 302 relative to the system clock.

For simplifying the description of the present invention, the destination core will be the first core 304 without limitation such that the present invention can have a latency value for each latency between the second core 312 and each of the cores 302. These latency values can be detected by the second latency detect circuit 504 and stored in the second latency storage 506.

The second latency compensator circuit 508 can extract the second latency value 516 from the second latency storage 506 to compensate for the latency between the cores 302. A second schedule circuit 518 of the second latency compensator circuit 508 can use the second latency value 516 to schedule the second data output 514 for transfer to the first core 304.

The second schedule circuit 518 can order the data for the second transfer 314 into a second data pipe 522 of the second latency compensator circuit 508. The second data pipe 522 can generate a second compensated data 524 by compensating the data for the second transfer 314 to shift timing of the data output earlier or later relative to the system clock. The second data pipe 522 can be bypassed or function as a block-to-block buffer to the second data output 514 resulting in an uncompensated data for the second compensated data 524.

As a different example, the second schedule circuit 518 can schedule the second round trip transfer 318 from the second core 312 to the first core 304 and returning back to the second core 312 for compensating the second latency value 516. The second schedule circuit 518 can compensate for the second round trip transfer 318 for the second latency value 516 from the second core 312 to the first core 304 and for another latency of the second latency value 516 back from the first core 304 to the second core 312.

For illustrative purposes, the second round trip transfer 318 is described with the latency from the second core 312 to the first core 304 is the same as the latency from the first core 304 to the second core 312, although it is understood that the second round trip transfer 318 may have different latency values based on direction. For example, second round trip transfer 318 is a combination of the second transfer 314 and the second transfer 316. The second transfer 314 can traverse different metal lines (not shown), vias (not shown), and distance (not shown) than the second transfer 316.

The second data input 512 can be connected to the second data output 514. This allows a second loopback transfer 530 of the data into the second core 312 to be transferred back out. An example of the second loopback transfer 530 can be back to the first core 304 as the core originating the incoming data.

The latency can be compensated as needed. For example, the second latency 516 can be updated based on changes environmental conditions to the integrated circuit device 202. Examples of the environmental changes include temperature and voltage.

If space, transistor count, gate court, or die size is of concern, the latency compensation can be performed by one or a portion of the cores 302. For example, the first core 304 can include the functional blocks discussed in FIG. 4. The second core 312, as an example, can optionally exclude the second latency detect circuit 504.

The second controller 502 can be implemented with different structures. For example, the second controller 502 can be implemented as a processor core, a bit sliced core, or a finite state machine. The second test pattern generator 510 can be implemented with different structures. For example, the second test pattern generator 510 can be implemented with a finite state machine for generating a training pattern, such as a synchronization pattern, a walking ones pattern, a walking zeroes pattern, or a reserved pattern, for the second test pattern 520.

The second latency storage 506 can be implemented with different structures. For example, the second latency storage 506 can be implemented with a static random access memory (SRAM), a non-volatile random access memory (NVRAM), a dynamic random access memory (DRAM), a register file, or a combination thereof

The second latency compensator circuit 508 can be implemented with different structures. For example, the second latency compensator circuit 508 can be implemented with analog circuitry, a single finite state machine, a number of finite state machines cooperating with each other, or a programmable finite state machine. The second schedule circuit 518 and the second data pipe 522 can also be implemented with various finite state machines. The second data pipe 522 can also be implemented with buffer structures, such as a second-in second-out (FIFO), a ring FIFO, a queue implemented with a FIFO, or a list implemented with a FIFO.

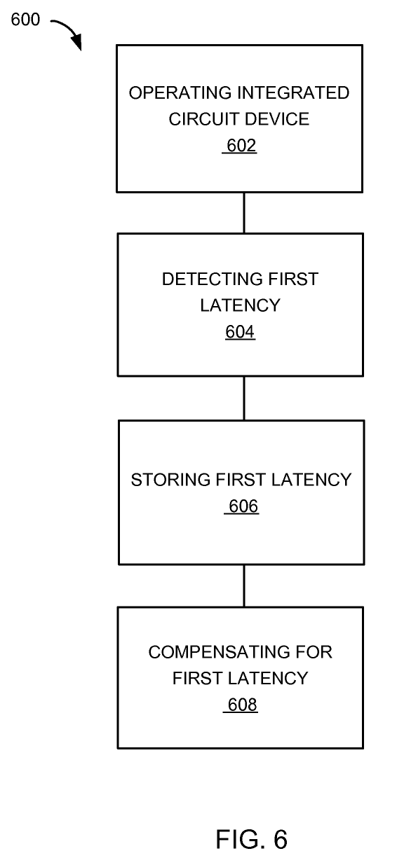

Referring now to FIG. 6, therein is shown a flow chart of a method 600 of operation of an electronic system 100 in a further embodiment of the present invention. The method 600 includes operating an integrated circuit device having a first core and a second core in a block 602; detecting a first latency value between the first core and the second core in a block 604; storing the first latency value in the first core in a block 606; and compensating for the first latency value in the first core for a first transfer between the first core and the second core in a block 608.

Yet other important aspects of the embodiments include that it valuably supports and services the historical trend of reducing costs, simplifying systems, and increasing performance.

These and other valuable aspects of the embodiments consequently further the state of the technology to at least the next level.

Thus, it has been discovered that the electronic system of the present invention furnishes important and heretofore unknown and unavailable solutions, capabilities, and functional aspects for improving reliability in systems. The resulting processes and configurations are straightforward, cost-effective, uncomplicated, highly versatile, and effective, can be implemented by adapting known technologies, and are thus readily suited for efficiently and economically manufacturing stackable integrated circuit package system.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of an electronic system comprising:
operating an integrated circuit device having a first core and a second core;
detecting a first latency value between the first core and the second core;
storing the first latency value in the first core; and
compensating for the first latency value in the first core for a first transfer between the first core and the second core.

2. The method as claimed in claim 1 wherein compensating for the first latency value in the first core for the first transfer between the first core and the second core includes scheduling the first transfer based on the first latency value from the first core to the second core.

3. The method as claimed in claim 1 wherein compensating for the first latency value in the first core for the first transfer between the first core and the second core includes scheduling the first transfer based on the first latency value for a round trip transfer from the first core to the second core and back to the first core.

4. The method as claimed in claim 1 wherein detecting the first latency value between the first core and the second core includes:
measuring a frequency of a first process detection circuit; and
mapping the frequency to the first latency value.

5. The method as claimed in claim 1 further comprising updating the first latency value between the first core and the second core.

6. A method of operation of an electronic system comprising:
operating an integrated circuit device having a first core and a second core;
detecting a first latency value between the first core and the second core with the first core;
storing the first latency value in the first core;
compensating for the first latency value in the first core for a first transfer between the first core and the second core;
detecting a second latency value between the second core and the first core;
storing the second latency value in the second core; and
compensating for the second latency value in the second core for a second transfer between the second core and the first core.

7. The method as claimed in claim 6 wherein compensating for the first latency value in the first core for the first transfer between the first core and the second core includes scheduling the first transfer based on the first latency value and the second latency value for a round trip transfer from the first core to the second core and back to the first core.

8. The method as claimed in claim 6 further comprising updating the second latency value between the second core and the first core.

9. The method as claimed in claim 6 wherein detecting the second latency value between the second core and the first core includes:
measuring a frequency of a second process detection circuit; and
mapping the frequency to the second latency value.

10. The method as claimed in claim 6 wherein detecting the second latency value between the second core and the first core includes measuring a performance sort ring oscillator.

11. An electronic system comprising:
an integrated circuit device having a first core and a second core;
a first latency detect circuit for detecting a first latency value between the first core and the second core;
a first latency storage for storing the first latency value in the first core; and
a first latency compensator circuit in the first core for compensating the first latency value for a first transfer between the first core and the second core.

12. The system as claimed in claim 11 wherein the first latency compensator circuit in the first core includes a first schedule circuit for scheduling the first transfer based on the first latency value from the first core to the second core.

13. The system as claimed in claim 11 wherein the first latency compensator circuit in the first core includes a first schedule circuit for scheduling the first transfer based on the first latency value for a round trip transfer from the first core to the second core and back to the first core.

14. The system as claimed in claim 11 wherein the first latency detect circuit includes:
a first process detection circuit for providing a frequency; and
a first process sense circuit for measuring the frequency for mapping the frequency to the first latency value.

15. The system as claimed in claim 11 further comprising a first controller for updating the first latency value between the first core and the second core.

16. The system as claimed in claim 11 wherein the second core includes:
a second latency detect circuit for detecting a second latency value between the second core and the first core;
a second latency storage for storing the second latency value in the second core; and
a second latency compensator circuit in the second core for compensating the second latency value for a second transfer between the second core and the first core.

17. The system as claimed in claim 16 wherein the first latency compensator circuit includes a first schedule circuit for scheduling the first transfer based on the first latency value and the second latency value for a round trip transfer from the first core to the second core and back to the first core.

18. The system as claimed in claim 16 further comprising a second controller for updating the second latency value between the second core and the first core.

19. The system as claimed in claim 16 wherein the second latency detect circuit for includes:
a second process detection circuit for providing a frequency; and
a second process sense circuit for measuring the frequency for mapping the frequency to the second latency value.

20. The system as claimed in claim 16 wherein the first detection circuit includes a performance sort ring oscillator.
